(19) United States
(12) Patent Application Publication
(10) Pub. No.: US 2004/0222406 A1
(43) Pub. Date: Nov. 11, 2004

(54) Positive temperature coefficient polymer composition and resettable fuse made therefrom

(75) Inventors: Jack Jih-Sang Chen, Taipei City (TW); Chi-Hao Gu, Pan-Chiao City (TW); Chang-Cheng Chiang, Hsing-Chuang City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Fuzetec Technology Co., Ltd.

(21) Appl. No.: 10/435,065

(22) Filed: May 8, 2003

(51) Int. Cl. H01B 1/00

(52) U.S. Cl. 252/500

(57) ABSTRACT

A PTC polymer composition contains a polymer mixture, a conductive particulate material, and a voltage resistance-enhancing agent of particulate metal oxide for enhancing voltage resistance of the polymer composition. The polymer mixture contains a crystalline grafted polymer and a crystalline non-grafted polymer.

### BACKGROUND OF THE INVENTION

1. Field of the invention

This invention relates to a positive temperature coefficient (PTC) polymer composition, more particularly to a PTC polymer composition with an improved voltage resistance and to a resettable fuse made therefrom.

2. Description of the related art

U.S. Pat. No. 6,238,598 discloses a PTC polymer composition that comprises a crystalline grafted polymer and a crystalline non-grafted polymer. Addition of the grafted polymer in the polymer composition improves the properties, such as peel strength, low contact resistance, low initial resistance, high trip current, and high peak volume resistance, of a PTC element made therefrom.

U.S. Pat. No. 6,359,053 discloses a PTC polymer composition that comprises a crystalline grafted polymer, a crystalline non-grafted polymer, and an ionomer of an ionic copolymer of the crystalline non-grafted polymer and an ionized unsaturated carboxylic acid. Addition of the ionic copolymer in the polymer composition improves the mechanical properties, such as toughness, good low temperature toughness, high impact strength, and high elasticity, of a PTC element made therefrom.

Circuit protection devices, such as a resettable fuse, made from the aforesaid conventional PTC polymer compositions normally have a low voltage resistance. For instance, a resettable fuse made from the aforesaid conventional PTC polymer compositions, which has a volume resistivity of less than 10 ohm-cm and which is particularly used in applications that operate at about 10-40 volts, normally has a maximum voltage rating at about 60 volts, i.e., the resettable fuse will likely break or burn out when the applied voltage reaches the maximum voltage resistance. Therefore, there is a need to increase the voltage resistance of the aforesaid conventional PTC polymer compositions without sacrificing other properties of the resettable fuse.

Commercial polymeric PTC heater devices are made from polymer compositions that have a volume resistivity of greater than 20 ohm-cm and often in a range of from 200-1000 ohm-cm. Such heater devices normally operate at a high voltage condition, e.g., 110-240 VAc or higher (above 600 VAc). As such, the polymer composition of this type has a relatively high voltage resistance which need not to be enhanced as required by that of the resettable fuse.

The entire disclosures of the aforementioned patents are incorporated herein by reference.

### SUMMARY OF THE INVENTION

Therefore, the object of the present invention is to provide a PTC polymer composition that is capable of providing an improved voltage resistance.

Another object of this invention is to provide a resettable fuse made from the polymer composition of the present invention.

According to the present invention, there is provided a PTC polymer composition that comprises a polymer mixture, a conductive particulate material dispersed in the polymer mixture, and a voltage resistance-enhancing agent. The polymer mixture contains (i) a crystalline grafted polymer and (ii) a crystalline non-grafted polymer. The crystalline grafted polymer is selected from a group consisting of grafted polyolefin, grafted polyolefin derivatives, and grafted copolymers of polyolefin and polyolefin derivatives. The grafted polymer is grafted by a polar group selected from a group consisting of carboxylic acids and derivatives thereof. The crystalline non-grafted polymer is selected from a group consisting of non-grafted polyolefin, non-grafted polyolefin derivatives, and non-grafted copolymers of polyolefin and polyolefin derivatives. The non-grafted polymer has a melting point substantially the same as that of the grafted polymer. The voltage resistance-enhancing agent comprises a particulate metal oxide material which is dispersed in the polymer mixture for increasing the voltage resistance of the polymer composition.

### DETAILED DESCRIPTION OF THE PREFERRED EMBODIMENT

The PTC polymer composition of this invention, which is particularly useful in the manufacture of a circuit protection device, such as a resettable fuse with a volume resistivity at 23° C. of less than 10 ohm-cm, particularly less than 5 ohm-cm, comprises a polymer mixture, a conductive particulate material dispersed in the polymer mixture, and a voltage resistance-enhancing agent. The polymer mixture contains (i) a crystalline grafted polymer, (ii) a crystalline non-grafted polymer, and optionally (iii) an ionic copolymer of the crystalline non-grafted polymer and an ionized unsaturated carboxylic acid. The crystalline grafted polymer is selected from a group consisting of grafted polyolefin, grafted polyolefin derivatives, and grafted copolymers of polyolefin and polyolefin derivatives. The grafted polymer is grafted by a polar group selected from a group consisting of carboxylic acids and derivatives thereof. The crystalline non-grafted polymer is selected from a group consisting of non-grafted polyolefin, non-grafted polyolefin derivatives, and non-grafted copolymers of polyolefin and polyolefin derivatives. The non-grafted polymer has a melting point substantially the same as that of the grafted polymer. The voltage resistance-enhancing agent comprises a particulate metal oxide material which is dispersed in the polymer mixture for increasing the voltage resistance (i.e., the resistance to damage attributed by an applied voltage) of the polymer composition. For the sake of clarity, a maximum voltage resistance of a resettable fuse is defined hereinafter as a value of voltage under which the resettable fuse break or burns out.

Preferably, the crystalline grafted polyolefin is selected from the group consisting of grafted high density polyethylene (HDPE), grafted low density polyethylene (LDPE), grafted linear low density polyethylene (LLDPE), grafted medium density polyethylene (MDPE), and grafted polypropylene (PP). More preferably, the crystalline grafted polyolefin is grafted HDPE. Preferably, the grafted copolymer of polyolefin and polyolefin derivatives is selected from a group consisting of grafted ethylene vinyl acetate (EVA) copolymer, grafted ethylene butyl acrylate (EBA) copolymer, grafted ethylene acrylic acid (EAA) copolymer, grafted ethylene methyl acrylic acid (EMAA) copolymer, and grafted ethylene methyl acrylic (EMA) copolymer.

Preferably, the crystalline non-grafted polyolefin is selected from the group consisting of non-grafted HDPE, non-grafted LDPE, non-grafted LLDPE, non-grafted MDPE, and non-grafted PP. More preferably, the crystalline non-grafted polyolefin is non-grafted HDPE. Preferably, the non-grafted copolymer of the polyolefin and the polyolefin derivatives is selected from a group consisting of non-grafted EVA, non-grafted EBA, non-grafted EAA, non-grafted EMAA, and non-grafted EMA.

The conductive particulate material is selected from a group consisting of carbon black, graphite, carbon fiber and metal powder particulate.

The unsaturated carboxylic acid included in the ionomer is selected from a group consisting of maleic anhydride, acrylic acid and acetic acid. Preferably, the unsaturated carboxylic acid is acrylic acid.

The metal oxide material of the voltage resistance-enhancing agent is preferably selected from a group consisting of zinc oxide, aluminum oxide, and magnesium oxide.

The polymer composition of this invention preferably contains from 25 to 70 wt % of the crystalline grafted polymer, from 25 to 70 wt % of the conductive particulate material, and from 5 to 30 wt % of the voltage resistance-enhancing agent, and more preferably contains from 40 to 50 wt % of the crystalline grafted polymer, from 40 to 50 wt % of the conductive particulate material, and from 10 to 20 wt % of the voltage resistance-enhancing agent. Preferably, the polymer mixture comprises 5 to 95% by weight of the crystalline grafted polymer and 5% to 95% by weight of the crystalline non-grafted polymer.

The merits of the polymer composition of this invention will become apparent with reference to the following Examples.

### EXAMPLES 1-10 AND COMPARATIVE EXAMPLES 1-8

Table 1 shows different formulations of the polymer composition of this invention and the conventional polymer composition. Test specimens, which are in the form of resettable fuses, prepared from the formulations listed in Table 1 were subjected to a Voltage resistance test (Examples 1 to 6 and Comparative Examples 1 to 4) in which the voltage applied to the test specimen was increased at a rate of 10V/min till the specimen reaches the maximum voltage resistance and burns out, and to a Short circuit test (Examples 7 to 10 and Comparative Examples 5 to 8) in which a sudden In-Rush current of 20A is applied to the test specimen at various voltages. Each test specimen was prepared by compounding and thermal molding the polymer composition to form a PTC element sheet, followed by attachment of two copper foils to two opposite sides of the PTC sheet for forming electrodes on the PTC sheet.

TABLE 1

| | Polymer Composition | | | | | |
|---|---|---|---|---|---|---|
| | | Grafted | Carbon | Aluminum | Zinc | Magnesium |
| Formu- | HDPE | PE | Black | Oxide | Oxide | Oxide |
| lation | wt % | wt % | wt % | wt % | wt % | wt % |
| 1 | 21 | 21 | 48 | 10 | 0 | 0 |
| 2 | 20 | 20 | 40 | 0 | 20 | 0 |
| 3 | 20 | 20 | 40 | 0 | 0 | 20 |
| 4 | 24 | 24 | 52 | 0 | 0 | 0 |

Results of the Voltage resistance test and the short circuit test are respectively shown in Table 2 and Table 3.

TABLE 2

| | | | Volume | |
|---|---|---|---|---|
| | | Thickness | Resistivity | Max. voltage |
| | formulation | mm | ohm-cm | resistance V |
| Examples | | | | |
| 1 | 1 | 0.3 | 3.5 | 220 |
| 2 | 1 | 0.4 | 3.5 | 300 |
| 3 | 1 | 0.5 | 3.6 | 320 |
| 4 | 1 | 0.6 | 3.5 | 330 |
| 5 | 2 | 0.6 | 3.6 | 360 |
| 6 | 3 | 0.6 | 3.5 | 205 |
| Comparative | | | | |
| Examples | | | | |
| 1 | 4 | 0.3 | 3.5 | 30 |
| 2 | 4 | 0.4 | 3.5 | 30 |
| 3 | 4 | 0.5 | 3.5 | 30 |
| 4 | 4 | 0.6 | 3.6 | 40 |

TABLE 3

| | | Applied | Volume | Number of | % of |
|---|---|---|---|---|---|
| | | voltage | Resistivity | specimens | specimens |
| Examples | formulation | V | ohm-cm | tested | burned |
| 7 | 1 | 60 | 3.5 | 36 | 0 |
| 8 | 1 | 70 | 3.5 | 36 | 0 |
| 9 | 1 | 80 | 3.5 | 36 | 0 |
| 10 | 1 | 90 | 3.5 | 36 | 3 |
| | | | Volume | Number of | % of |
| Comparative | | Applied | Resistivity | specimens | specimens |
| Examples | formulation | voltage | ohm-cm | tested | burned |
| 5 | 4 | 60 | 3.5 | 47 | 0 |
| 6 | 4 | 70 | 3.5 | 47 | 4 |
| 7 | 4 | 80 | 3.5 | 45 | 4 |
| 8 | 4 | 90 | 3.5 | 43 | 35 |

Results of the Voltage test and the Short circuit test show that addition of the voltage resistance-enhancing agent into the polymer composition of the present invention significantly enhances the voltage resistance of the polymer composition of this invention as compared to the conventional polymer compositions disclosed in the aforesaid U.S. patents.

With the invention thus explained, it is apparent that various modifications and variations can be made without departing from the spirit of the present invention. It is therefore intended that the invention be limited only as recited in the appended claims.

We claim:

1. A positive temperature coefficient polymer composition comprising:
a polymer mixture containing
(i) a crystalline grafted polymer selected from a group consisting of grafted polyolefin, grafted polyolefin derivatives, and grafted copolymers of polyolefin and polyolefin derivatives, said grafted polymer being grafted by a polar group selected from a group consisting of carboxylic acids and derivatives thereof, and
(ii) a crystalline non-grafted polymer selected from a group consisting of non-grafted polyolefin, non-grafted polyolefin derivatives, and non-grafted copolymers of polyolefin and polyolefin derivatives, said non-grafted polymer having a melting point substantially the same as that of said grafted polymer;
a conductive particulate material dispersed in the polymer mixture; and
a voltage resistance-enhancing agent that comprises a particulate metal oxide material which is dispersed in the polymer mixture for increasing the voltage resistance of said polymer composition.

2. The polymer composition of claim 1, wherein said crystalline grafted polyolefin is selected from a group consisting of grafted HDPE, grafted LDPE, grafted LLDPE, grafted MDPE, and grafted PP.

3. The polymer composition of claim 1, wherein said crystalline non-grafted polyolefin is selected from a group consisting of non-grafted HDPE, non-grafted LDPE, non-grafted LLDPE, non-grafted MDPE, and non-grafted PP.

4. The polymer composition of claim 1, wherein said conductive particulate material is selected from a group consisting of carbon black, graphite, carbon fiber, and metal powder particulate.

5. The polymer composition of claim 1, wherein said metal oxide material is selected from a group consisting of zinc oxide, aluminum oxide, and magnesium oxide.

6. The polymer composition of claim 1, wherein said voltage resistance-enhancing agent is present in an amount up to 30 wt % of the composition.

7. The polymer composition of claim 1, wherein said voltage resistance-enhancing agent is present in an amount from 5 to 20 wt % of the composition.

8. The polymer composition of claim 1, wherein said polymer mixture is present in an amount from 25 to 70 wt % of the composition, said conductive particulate material is present in an amount from 25 to 70 wt % of the composition, and said voltage resistance-enhancing agent is present in an amount from 5 to 30 wt % of the composition.

9. The polymer composition of claim 1, wherein said polymer mixture is present in an amount from 40 to 60 wt % of the composition, said conductive particulate material is present in an amount from 40 to 60 wt % of the composition, and said voltage resistance-enhancing agent is present in an amount from 5 to 25 wt % of the composition.

10. The polymer composition of claim 1, wherein said polymer mixture is present in an amount from 40 to 50 wt % of the composition, said conductive particulate material is present in an amount from 40 to 50 wt % of the composition, and said voltage resistance-enhancing agent is present in an amount from 10 to 20 wt % of the composition.

11. The polymer composition of claim 1, wherein said polymer mixture comprises 5 to 95% by weight of said crystalline grafted polymer and 5% to 95% by weight of said crystalline non-grafted polymer.

12. The polymer composition of claim 1, wherein said polymer mixture further contains an ionic copolymer of said crystalline non-grafted polymer and an ionized unsaturated carboxylic acid.

13. The polymer composition of claim 1, wherein said polymer mixture further contains an ionic copolymer of said crystalline non-grafted polymer and an ionized unsaturated carboxylic acid.

14. The polymer composition of claim 13, wherein said unsaturated carboxylic acid is selected from a group consisting of maleic anhydride, acrylic acid and acetic acid.

15. A positive temperature coefficient polymer composition having a volume resistivity at 23° C. of less than 10 ohm-cm, said polymer composition comprising:
a polymer mixture containing
(i) a crystalline grafted polymer selected from a group consisting of grafted polyolefin, grafted polyolefin derivatives, and grafted copolymers of polyolefin and polyolefin derivatives, said grafted polymer being grafted by a polar group selected from a group consisting of carboxylic acids and derivatives thereof, and
(ii) a crystalline non-grafted polymer selected from a group consisting of non-grafted polyolefin, non-grafted polyolefin derivatives, and non-grafted copolymers of polyolefin and polyolefin derivatives, said non-grafted polymer having a melting point substantially the same as that of said grafted polymer;
a conductive particulate material dispersed in the polymer mixture; and
a voltage resistance-enhancing agent that comprises a particulate metal oxide material which is dispersed in the polymer mixture for increasing the voltage resistance of said polymer composition.

16. The polymer composition of claim 15, wherein said metal oxide material is selected from a group consisting of zinc oxide, aluminum oxide, and magnesium oxide.

17. The polymer composition of claim 15, wherein said voltage resistance-enhancing agent is present in an amount up to 30 wt % of the composition.

18. The polymer composition of claim 15, wherein said voltage resistance-enhancing agent is present in an amount from 5 to 20 wt % of the composition.

19. The polymer composition of claim 15, wherein said polymer mixture is present in an amount from 40 to 50 wt % of the composition, said conductive particulate material is present in an amount from 40 to 50 wt % of the composition, and said voltage resistance-enhancing agent is present in an amount from 10 to 20 wt % of the composition.

20. The polymer composition of claim 15, wherein said polymer mixture further contains an ionic copolymer of said crystalline non-grafted polymer and an ionized unsaturated carboxylic acid.

21. A resettable fuse comprising:
(a) a PTC element having a volume resistivity at 23° C. of less than 10 ohm-cm and a polymer composition that comprises
a polymer mixture containing,
(i) a crystalline grafted polymer selected from a group consisting of grafted polyolefin, grafted polyolefin derivatives, and grafted copolymers of polyolefin and polyolefin derivatives, said grafted polymer being grafted by a polar group selected from a group consisting of carboxylic acids and derivatives thereof, and
(ii) a crystalline non-grafted polymer selected from a group consisting of non-grafted polyolefin, non-grafted polyolefin derivatives, and non-grafted copolymers of polyolefin and polyolefin derivatives, said non-grafted polymer having a melting point substantially the same as that of said grafted polymer,
a conductive particulate material dispersed in the polymer mixture, and
a voltage resistance-enhancing agent that comprises a particulate metal oxide material which is dispersed in the polymer mixture for increasing the voltage resistance of said polymer composition; and
(b) two electrodes connected respectively to two opposite sides of said PTC element.

22. The resettable fuse of claim 21, wherein said polymer mixture further contains an ionic copolymer of said crystalline non-grafted polymer and an ionized unsaturated carboxylic acid.
